(19) United States
(12) Patent Application Publication
(10) Pub. No.: US 2013/0131224 A1
(43) Pub. Date: May 23, 2013

(54) BIODEGRADABLE COMPOSITION HAVING HIGH MECHANICAL CHARACTERISTICS

(71) Applicant: Novamont S.p.A, Novara (IT)

(72) Inventors: Catia Bastioli, Novara (IT); Angelos Rallis, Novara (IT); Roberto Lombi, Novara (IT)

(73) Assignee: Novamont S.p.A., Novara (IT)

(21) Appl. No.: 13/706,938

(22) Filed: Dec. 6, 2012

Related U.S. Application Data
(62) Division of application No. 12/518,754, filed on Jun. 11, 2009, now abandoned.

(30) Foreign Application Priority Data
Dec. 12, 2006 (IT) MI2006A002375

(51) Int. Cl. C08L 29/04

(52) U.S. Cl. CPC C08L 29/04
USPC 524/47

(57) ABSTRACT

A starch based biodegradable composition comprising starch, a polyvinyl alcohol covinyl acetate copolymer and pentaerythritol, which can be produced industrially according to the techniques commonly used for traditional plastics is provided.

### CROSS REFERENCE TO RELATED APPLICATIONS

This application is a Divisional of co-pending application Ser. No. 12/518,754, filed on Jun. 11, 2009, which is a National Stage of PCT/EP2007/063742, filed on Dec. 11, 2007; and this application claims priority of Application No. MI2006A002375 filed in Italy on Dec. 12, 2006 under 35 U.S.C. §119; the entire contents of all are hereby incorporated by reference.

### DESCRIPTION

1. Field of Disclosure

The present invention relates to a starch based biodegradable composition comprising starch, a polyvinyl alcohol-co-vinyl acetate copolymer and pentaerythritol, which can be produced industrially according to the techniques commonly used for traditional plastics. There is, in recent years, an increasing demand for biodegradable materials with high oxygen barrier properties capable at the same time to maintain high tensile properties and being additionally characterized by an excellent filmability.

The purpose of the present invention is therefore to provide a biodegradable composition having high mechanical properties, particularly high elastic modulus, high load at break and high energy at break associated with the high oxygen barrier property characterizing the polyvinyl alcohol-co-vinyl acetate copolymers and starch.

Such composition is particularly suitable for the production of multilayer packaging products with high oxygen barrier for the packaging of food, pharmaceutical and active molecules in general.

In particular, the present invention relates to a starch based biodegradable composition comprising, on a dry basis with respect to the total weight of the dry composition:
non converted starch, present in quantity of 15%-70%;
a polyvinylalcohol-co-vinylacetate copolymer present in quantity of 5%-50%;
plasticizer present in quantity comprised between 5% and 45%;
   characterized by the fact that said plasticizer contains pentaerythritol in quantity of 45%-85%, with respect to the total weight of the plasticizer, said composition having an elastic modulus comprised between 300 and 2500 MPa, energy at break >1000 kJ/m² and load at break >23 MPa, measured at 23° C. and 55% of relative humidity on a 30-50 micrometers film.

2. Background Art

Compositions containing starch, polyvinyl alcohol and a plasticizer are known in the in the prior art. The prior art, however, does not describe compositions having the specific starch, polyvinyl alcohol-co-vinylacetate copolymer and plasticizer ratio with the specific pentaerythritol ratio in the plasticizer and with the excellent mechanical properties according to the present invention.

### SUMMARY OF DISCLOSURE

The composition according to the present invention presents excellent rheological characteristics since the specific pentaerythritol ratio improves the composition fluidity. Particularly, at low shear values (such as 70-250γₐₚ), the viscosity of the composition is more similar to the viscosity of a composition without pentaerythritol and with just a liquid plasticizer such as glycerol. The composition according to the present invention is therefore easily processable, and particularly filmable, notwithstanding its properties, such as rigidity, which are closer to the ones of a composition with high pentaerythritol content.

The characteristics and advantages of the biodegradable composition according to the invention will emerge clearly from the following description.

### BRIEF DESCRIPTION OF FIGURE

The FIGURE illustrates a molded article employing the biodegradable composition of the present disclosure.

### DESCRIPTION OF BEST AND VARIOUS EMBODIMENTS FOR CARRYING OUT DISCLOSURE

As mentioned above, the biodegradable composition according to the present invention comprises starch, a polyvinyl alcohol-polyvinyl acetate copolymer, and pentaerythritol in quantity of 45-85% of the total quantity of plasticizer.

With the term “starch” are meant herein all types of non converted starch, with the term “converted” being meant a starch with a much lower average molecular weight than native starch. The conversion process usually involves breaking, rearranging and/or recombining the starch chains through the action of several agents such as e.g. acids.

Non converted starch according to the present invention therefore means starch not in the form of natural fibers (such as corn fibers), particularly: flour, native starch, chemically and/or physically modified starch, desctructurized starch, gelatinized starch, thermoplastic starch and their mixtures. Particularly suitable according to the invention are native potato starch, wheat starch, legume starch, sorghum starch, tapioca, yucca, and maize starch. Native potato and maize starch are particularly preferred.

In the composition according to the invention, the dry starch is present in a quantity comprised between 15 and 70 wt %, preferably between 20 and 60 wt %, more preferably between 25 and 45 wt % with respect to the total of the dry composition.

As regards the polyvinyl alcohol-co-vinyl acetate copolymer, it is present in a quantity comprised between 5 and 50 wt %, preferably between 10 and 48 wt %, more preferably between 20 and 45 wt % with respect to the total of the dry composition.

The polyvinyl alcohol-co-vinyl acetate copolymer has a degree of hydrolysis >70%, preferably >75%, more preferably >80%. The number average molecular weight of PVOH is of 30.000-150.000, preferably of 40.000-120.000.

The plasticizer of the composition according to the present invention comprises 45-85%, preferably 50-80% by weight of pentaerythritol.

Said plasticizer is present in an amount of 5-45% by weight of the total dry composition, preferably 10-40% and more preferably 15-35%.

Plasticizers different from pentaerythritol are selected from the group of plasticizers that do not have carboxyl groups. Particularly, plasticizers different from pentaerythritol that do not have carboxyl groups are compounds having a molecular weight >2000 but having at least one hydroxyl group. Advantageously, the plasticizers that are different from pentaerythritol comprise low molecular weight poly(alkylene glycols), such as poly(ethylene glycols), poly(propylene glycols), poly(ethylenepropylene glycols); polyols, such as glycerol, sorbitol, arabitol, adonitol, xylitol, mannitol, iditol, trimethylolpropane and mixtures thereof. The Polyols are preferred.

Glycerine and plasticizers liquid at room temperature and their mixtures are particularly preferred.

Due to the presence of polyvinyl alcohol-polyvinyl acetate copolymer and starch the biodegradable composition according to the present invention has high oxygen barrier properties.

Furthermore, the biodegradable composition described in the present invention has high mechanical properties measured at T=23° C. and 55% of relative humidity on a 30-50 micrometers film, in particular an elastic modulus of 300-2500 MPa, preferably 450-2000 MPa, an energy at break >1000 kJ/m², preferably >1200 kJ/m², more preferably >1500 kJ/m², and a load at break >23 MPa , preferably >25 MPa, preferably >30 MPa.

The composition according to the present invention is biodegradable according to the ISO 14851 and ISO 14852 Standard.

Other substances can obviously be added to the present composition such as colorants, aromas, foodstuff integrators, fibres, as well as process additives such as, for example, fluidifying and slipping agents. Particularly noticeable is that the high mechanical properties, the excellent processability and high oxygen barrier properties of the composition according to the present invention are obtained without the addition of hydrogen bond breakers, such as urea. It is of particular interest the use of micro and nanoparticles of cationic or anionic nature such as mortmorillonites and hydrotalcite. They can be used in the ionic form or can be functionalized with chemicals to change the affinity with the composition. The films can also contain particles of silver or titanium oxide in micro and nanodispersions.

The films and sheets of the composition can be also treated superficially with water resistant coatings of silica, siloxanes, aluminum etc. Cold plasma treated surfaces are of particular interest.

The process additives are preferably selected from the group consisting of fatty acids amides (such as erucamide), calcium stearate and zinc stearate and are present in quantities comprised between 0.1 and 5 wt %, preferably between 0.5 and 3 wt % with respect to the total of the dry composition.

The composition according to the present invention is advantageously obtainable by an extrusion process in which the polyvinylalcohol-co-vinylacetate copolymer is not pre-plasticized and wherein the water content at the inlet of the extruder is above 10%, preferably above 12% more preferably above 15% with respect to the total weight of the composition and the water content is then reduced by degassing at a content <7% preferably <5% with respect to the total weight of the composition.

The biodegradable composition according to the invention is suitable for producing profiles, fibres, and injection-moulded or blow-moulded objects, such as disposable articles, blown films, casting films and sheets for thermoforming.

The composition is particularly suitable for making flexible, and rigid films/sheets.

Due to its properties, the composition according to the present invention has excellent filmability which makes it easy to process also with conventional film machines. The films thus obtained can be further transformed by several technologies such as lamination-on paper, aluminium, biodegradable and non biodegradable plastic films and their combinations to make multilayer packaging products-, extrusion coating and co-extrusion coating—for several application such as metal and paper coating, food and beverage packaging, such as tetrapak®—fibers production, such as composite fibres, microfibres and nanofibers.

Applications particularly suitable are multilayer packaging structures containing:

A layer of coated or uncoated paper or cellulose acetate or cellophane, or biodegradable or non biodegradable plastic, optionally a tie layer or glue, a layer of the composition object of the present invention, optionally a tie layer or a glue and another layer of coated or uncoated paper or cellulose acetate or cellophane, or biodegradable or non biodegradable plastic.

The plastic can be a traditional one such as PE, PP, OPP, PET, and the ilke.

The biodegradable plastics can be polylactic acid (PLA) and its blends, polyhydroxyalcanoates and their blends, starch based materials and their blends, polybuthylene succinate polymer and copolymers and their blends, polybuthylene terephtalate copolymers with adipic acid, dieptanoic acid, dioctanoic acid, azelaic acid, sebacic acid, diundecanoic acid, didodecanoic acid, brassylic acid etc, polyalkylene azelates, polyalkylene sebacates, polyalkylenebrassylates, polyalkylenedidodecanoates, polyalkylenediundecanoates and their combinations.

The multilayer structures can have a symmetric profile with the external layers of the same nature or they can have an asymmetric profile with the two external layers of different nature.

Such structures can be particularly suitable in “tetrapack” like packaging, in thermoformed trays, in closers for trays and cups, in containers of different type.

Such containers are used in case of products particularly sensitive to oxidation. Examples can be found in the sector of food and non food products, such as milk, fruit juices, dairy products in general, meat, ham and the like, pharmaceutical products, agricultural products.

Another use can be the one of the slow release of active substances. In such a case the container or sandwich made of the composition and containing the active substance, possibly superficially treated with coating as reported above, can be dissolved in water or a solvent to release the active substance itself.

The biodegradable composition according the present invention is also advantageously suitable for producing injection moulding objects, such as pet toys, needles for grass carpets, cotton buds sticks and toys, with very high mechanical properties also in low relative humidity conditions. In particular, the injection moulded products thus obtained are characterized by an impact energy >80 kJ/m², preferably >100 kJ/m² at 30% of relative humidity, and >10 kJ/m², preferably >15 kJ/m² at 0% of relative humidity.

The invention will now be described by means of some embodiments provided purely by way of example. In brackets are reported the percentage values of the dry composition.

### EXAMPLE 1

A twin-screw extruder having D=30 mm, L/D=40, was supplied with:
36.6 (39.1) wt % maize starch (containing 12% of water)
30.6 (37.1) wt % PVOH, with a degree of hydrolysis of 88%
5.9 (7.1) wt % glycerine
13.2 (16) wt % pentaerythritol
13.2 wt % water
0.5 (0.6) wt % slipping agent

Operating conditions of the extruder:
thermal profile: 60-120-170×14
r.p.m.=170
active degassing

The material was granulated at the exit of the extruder's die. Granules were obtained that were air cooled.

The water content is 2.5% with respect to the total weight of the granule.

The granules thus obtained were subsequently blown filmed.

The operating conditions of the film machine, were the following:

Single-screw extruder having D=19 mm, L/D=25,
film temperature: 170° C.
film thickness: 30-50 μm

### Mechanical Characterization

The film thus obtained was subjected to mechanical characterization, in particular to the determination of tensile properties according the ASTM D882 test method. The results appearing in Table 1 were obtained.

### EXAMPLE 2

A twin-screw extruder having D=30 mm, L/D=40, was supplied with:
30 (31.7) wt % maize starch (containing 12% of water)
36 (43.3) wt % PVOH, with a degree of hydrolysis of 88%
4.8 (5.8) wt % glycerine
15.5 (18.6) wt % pentaerythritol
13.2 wt % water
0.5 (0.6) wt % slipping agent

Operating conditions of the extruder:
thermal profile: 60-120-170×14
r.p.m.=170
active degassing

The material was granulated at the exit of the extruder's die. Granules were obtained that were air cooled.

The water content is 2.93% with respect to the total weight of the granule.

The granules thus obtained were subsequently filmed.

The operating conditions of the film machine, were the following:

Single-screw extruder having D=19 mm, L/D=25,

Film temperature: 170° C.

Film thickness: 30-50 um

### Mechanical Characterization

The film thus obtained was subjected to a test of mechanical characterization, in particular to the determination of tensile properties according the ASTM D882 test method. The results appearing in Table 1 were obtained.

### EXAMPLE 3

A twin-screw extruder having D=30 mm, L/D=40, was supplied:
35.7 (38%) wt % maize starch (containing 12% of water)
29.9 (36.1) wt % PVOH, with a degree of hydrolysis of 88%
7.9 (9.5) wt % glycerine
13 (15.7) wt % pentaerythritol
13 wt % water
0.5 (0.6) wt % slipping agent

Operating conditions of the extruder:
thermal profile: 60-120-170×14
r.p.m.=170
active degassing

The material was granulated at the exit of the extruder's die. Granules were obtained that were air cooled.

The water content is 4.4% with respect to the total weight of the granule.

The granules thus obtained were subsequently filmed.

The operating conditions of the film machine, were the following:

Single-screw extruder having D=19 mm, L/D=25,

Film temperature: 170° C.

Film thickness: 30-50 um

### Mechanical Characterization

The film thus obtained was subjected to a mechanical characterization, in particular to the determination of tensile properties according the ASTM D882 test method. The results appearing in Table 1 were obtained.

TABLE 1

| | Elastic modulus | Energy at break | Load at break |
|---|---|---|---|
| Example | (MPa) | (kJ/m²) | (MPa) |
| 1 | 1242 | 2863 | 45.2 |
| 2 | 1424 | 2834 | 46.8 |
| 3 | 988 | 2707 | 35.5 |

### EXAMPLE 4

A twin-screw extruder having D=30 mm, L/D=35 was supplied with:
35.5 (37.71) wt % maize starch (containing 12% of water)
29.7 (35.85) wt % PVOH, with a degree of hydrolysis of 88%
9.0 (10.86) wt % glycerine
12.9 (15.57) wt % pentaerythritol
12.9 wt % water

Operating conditions of the extruder:
thermal profile: 30-90-170×8-150×4
flow rate: 10.1 kg/h
r.p.m.=170
active degassing

The material at output from the die was cut from the head of the latter. Granules were obtained that were air cooled.

The granules thus obtained were subsequently supplied to a press for injection moulding.

The operating conditions of the injection press Mod. Sandretto S/7, in which a bone-shaped die was present, were the following:
thermal profile: 140-150-160-170° C.
rate of injection: 40 cm³/s

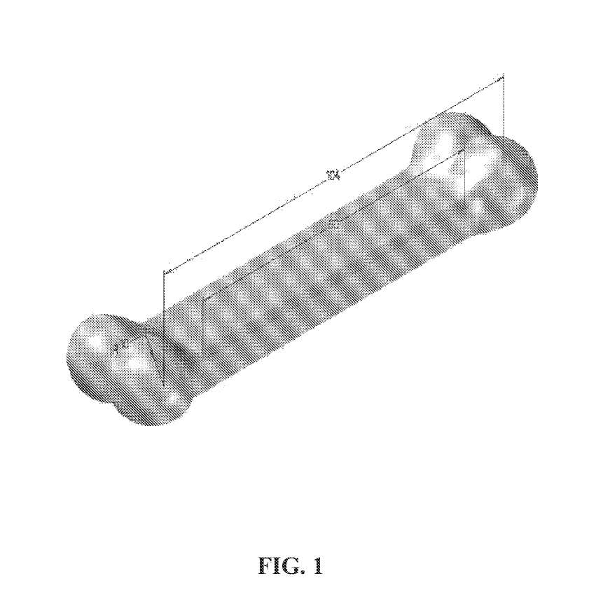

FIG. 1 shows the dimensions of the bone obtained in mm.

### Mechanical Characterization

The bone thus obtained was subjected to a test of mechanical characterization, in particular an impact test of a Charpy type. The bone had an impact area of 19 mm×12 mm with curvatures angle of 2 mm in the upper face and of 4 mm in the lower face.

The impact energy was measured at T=23° C. in different conditions of relative humidity, and the results appearing in Table 2 were obtained.

### 4 COMPARISON EXAMPLE

The extruder of Example 1 was supplied with:
35.5 (35.36) wt % maize starch (containing 12% of water)
29.7 (33.62) wt % PVOH, with a degree of hydrolysis equal to 88%
9.0 (10.18) wt % glycerine
18.4 (20.82) wt % sorbitol
7.4 wt % water

The material was extruded in the same operating conditions as those of Example 1.

The material at output from the die was cut from the head of the latter. Granules were obtained that were air cooled.

The granules thus obtained were subjected to tests of mechanical characterization.

The granules thus obtained were subsequently supplied to the press for injection moulding used for Example 4 and subjected to a moulding cycle in the same operating conditions as those of Example 4.

The bone obtained had the same dimensions of the Example 4

### Mechanical Characterization

The bone thus obtained was subjected to a test of mechanical characterization, in particular an impact test of a Charpy type. The bone had the same impact area of the Example 4. The impact energy was measured at T=23° C. in different conditions of relative humidity, and the results appearing in Table 2 were obtained.

TABLE 2

| | | Impact energy |
|---|---|---|
| Example | Relative humidity % | (kJ/m²) |
| 4 | 30 | 123 |
| 4 Comparison | 30 | 19 |
| 4 | 0 | 20 |
| 4 Comparison | 0 | 6 |

1. An extrusion process for preparing a biodegradable product comprising, on a dry basis with respect to the total weight of the product:
non converted starch, present in a quantity of 15% to 70%;
a polyvinylalcohol-co-vinylacetate copolymer present in a quantity of 5% to 50%;
plasticizers present in a quantity between 5% and 45%;
wherein said plasticizers contain pentaerythritol in a quantity of 45% -85%, with respect to the total weight of the plasticizers, said product having elastic modulus between 300 and 2500 MPa, energy at break >1000 kJ/m² and load at break >23 MPa, measured at 23° C. and 55% of relative humidity on a 30-50 micrometers film, said composition having a water content of less than 5% with respect to the total weight of the product;
wherein said extrusion comprises extruding in extruder having an inlet and an outlet and is characterized by the fact that the polyvinylalcohol-co-vinylacetate is not preplasticized and wherein the water content at the inlet of the extruder is above 10% with respect to the total weight of the composition and the water content is reduced by degassing at a content lower than 5% with respect to the total weight of the composition.

2. The extrusion process for preparing a biodegradable product according to claim 1, wherein the non converted starch is present in a quantity of 20 to 60 wt %, the polyvinyl alcohol co-vinyl acetate copolymer is present in a quantity of 10-48 wt % and the plasticizers are present in a quantity of 10-40 wt % with respect to the total weight of the dry product.

3. The extrusion process for preparing a biodegradable product according to claim 2, wherein the non converted starch is present in a quantity of 25-45 wt %, the polyvinyl alcohol co-vinyl acetate copolymer is present in a quantity of 20-45 wt % and the plasticizers are present in a quantity of 15-35 wt % with respect to the total weight of the dry product.

4. The extrusion process for preparing a biodegradable product according to claim 1, wherein the plasticizers contain pentaerythritol in a quantity of 50-80% with respect to the total weight of the plasticizers, said product having an elastic modulus comprised between 450 and 2000 MPa, an energy at break >1200 kJ/m² and a load at break >25 MPa measured at 23° C. and 55% of relative humidity on a 30-50 micrometers film.

5. The extrusion process for preparing a biodegradable product according to claim 4 wherein the product has an energy at break >1500 kJ/m² and a load at break >30 MPa.

6. The extrusion process for preparing a biodegradable product according to claim 1, wherein the non converted starch is maize starch.

7. The extrusion process for preparing a biodegradable product according to claim 1, wherein the polyvinyl alcohol-co-vinyl acetate copolymer has a degree of hydrolysis >75%.

8. The extrusion process for preparing a biodegradable product according to claim 7, wherein the polyvinyl alcohol-co-vinyl acetate copolymer has a degree of hydrolysis >80%.

9. The extrusion process for preparing a biodegradable product according to claim 1, in which plasticizers different from pentaerythritol are compounds that do not have a molecular weight >2000 and do not have a carboxyl group, but have at least one hydroxyl group.

10. The extrusion process for preparing a biodegradable product according to claim 9, wherein the plasticizers different from pentaerythritol comprise low molecular weight poly(alkylene oxides), polyols and mixtures thereof.

11. The extrusion process for preparing a biodegradable product according to claim 10, wherein the plasticizers different from pentaerythritol are polyols.

12. The extrusion process for preparing a biodegradable product according to claim 11, wherein the plasticizers different from pentaerythritol are selected from the group consisting of glycerine, sorbitol and mixtures thereof.

13. The extrusion process for preparing a biodegradable product according to claim 1, wherein the product further comprises substances selected from the group constituted by colorants, aromas, foodstuff integrators and fibres.

14. The extrusion process for preparing a biodegradable product according to claim 1, wherein the product further comprises process additives selected from the group comprising fluidifying, slipping and gliding agents but not hydrogen bond breakers.

15. The extrusion process for preparing a biodegradable product according to claim 14, wherein the process additives comprise fatty acids amides, calcium stearate and zinc stearate.

16. The extrusion process for preparing a biodegradable product according to claim 15, wherein said process additives are present in quantities of 0.1-5 wt %, with respect to the total of the product.

17. The extrusion process for preparing a biodegradable product according to claim 16, wherein said process additives are present in quantities of 0.5-3 wt %, with respect to the total of the product.

18. The extrusion process for preparing a biodegradable product according to claim 1, wherein the water content at the inlet of the extruder is above 12% and the water content is reduced by degassing during the extrusion at a content lower than 5% with respect to the total weight of the product.

19. The extrusion process for preparing a biodegradable product according to claim 18, wherein the water content at the inlet of the extruder is above 15% with respect to the total weight of the composition.

20. The extrusion process for preparing a biodegradable product according to claim 1, wherein said product is an article selected from the group consisting of profiles, fibres, injection-moulded or blow-moulded objects, blown films, casting films and sheets for thermoforming.

21. The extrusion process for preparing a biodegradable product according to claim 20, wherein said article is a flexible or rigid film/sheet.

22. The extrusion process for preparing a biodegradable product according to claim 20, wherein said article is a films obtained from said biodegradable product for lamination-on paper, aluminium, biodegradable and non biodegradable plastic films and their combinations to make multilayer packaging products, extrusion coating and co-extrusion coating for application selected from the group consisting of metal and paper coating, food and beverage packaging, and fibers production.

23. The extrusion process for preparing a biodegradable product according to claim 20, wherein said article has an impact energy >80 kJ/m² at 23° C. and 30% of relative humidity and >10 kJ/m² at 0% of relative humidity.

24. The extrusion process for preparing a biodegradable product according to claim 23, wherin said article is selected from the group consisting of pet toys, needles for grass carpets, cotton buds sticks and toys.

25. The extrusion process for preparing a biodegradable according to claim 1 wherein said product is biodegradable according to the ISO 14851 and ISO 14852 Standard.
